(19) United States
(12) Patent Application Publication
(10) Pub. No.: US 2021/0067824 A1
(43) Pub. Date: Mar. 4, 2021

(54) VIDEO STREAM CHECK METHOD AND SYSTEM, COMPUTER DEVICE AND STORAGE MEDIUM

(71) Applicant: ZICT TECHNOLOGY CO., LTD., Shenzhen (CN)

(72) Inventors: Fuqun LI, Shenzhen (CN); Dalin YING, Shenzhen (CN); Chong LUO, Shenzhen (CN)

(73) Assignee: ZICT TECHNOLOGY CO., LTD., Shenzhen (CN)

(21) Appl. No.: 16/957,815

(22) PCT Filed: Jul. 11, 2018
(86) PCT No.: PCT/CN2018/095280

§ 371 Date: Jun. 25, 2020

(30) Foreign Application Priority Data
Dec. 29, 2017 (CN) 201711478498.2

(51) Int. Cl. H04N 21/262; H04N 17/00; H04N 21/24

(52) U.S. Cl. CPC H04N 21/26291; H04N 17/004; H04N 21/26258; H04N 21/26208; H04N 21/2407

(57) ABSTRACT

Provided are a video stream check method, a video stream check system, a computer device and a computer-readable storage medium. The video stream check method is applied to a video management platform. The video management platform includes a central service module. The check method includes acquiring a video resource list from the central service module; grouping video resources in the video resource list and performing a real-time cyclic preview of the grouped video resources; determining status of the video resources based on the result of the real-time cyclic preview; and reporting the status of the video resources to the central service module so that the central service module updates original status of the video resources to the determined status of the video resources and notifies the updated status of the video resources to other applications of the video management platform.

This application claims priority to Chinese patent application No. 201711478498.2 filed with the CNIPA on Dec. 29, 2017, disclosure of which is incorporated herein by reference in its entirety.

### TECHNICAL FIELD

The present disclosure relates to the field of security video management technology, for example, to a video stream check method, a video stream check system, a computer device and a computer-readable storage medium.

### BACKGROUND

In a video management platform of the security market, the central service is a software entity that manages online and offline status of a camera. When the video management platform starts to connect to a device such as a video recorder, a camera or a lower-level video management platform, the device actively sends the current available or unavailable status of all video streams managed by the device itself to the central service. When the available or unavailable status of a video stream managed by the device changes, the device actively notifies the central service to change the status of the video stream. However, in practical application, since there are many manufacturers of devices like cameras, video recorders and video management platforms on the security market, various connections exist between different devices for the purpose of achieving the top-down management function of the devices. The connections include a connection between a camera and a video recorder, a connection between a camera and a video management platform, a connection between a video recorder and a video management platform, and a connection between a lower-level video management platform and an upper-level video management platform.

In each of the preceding connections, different device manufacturers tend to have different connection protocols, increasing an inconsistency in connections between video products. Each manufacturer has a different production technology level, each manufacturer has a different understanding of a connection protocol, each person making a connection has a different professional skill, and some manufacturers have set technical barriers. Thus, a connected video management platform has many problems in practical application. For example, the available or unavailable status of part of video streams is incorrect and, among cameras managed by a video management platform, some available cameras cannot be used for viewing real-time videos while some unavailable cameras can be used for viewing real-time videos. As a result, after connected to a device produced by another manufacturer, the video management platform cannot accurately determine whether a video stream is valid.

### SUMMARY

The present disclosure provides a video stream check method. The video stream check method is applied to a video management platform. The video management platform includes a central service module. The check method includes acquiring a video resource list from the central service module; grouping video resources in the video resource list and performing a real-time cyclic preview of the grouped video resources; determining status of the video resources based on the result of the real-time cyclic preview; and reporting the status of the video resources to the central service module so that the central service module updates original status of the video resources to the determined status of the video resources and notifies the updated status of the video resources to other applications of the video management platform.

The present disclosure further provides a video stream check system. The video stream check system is applied to a video management platform. The video management platform includes an acquisition unit configured to acquire a video resource list from the central service module; a preview unit configured to group video resources in the video resource list and perform a real-time cyclic preview of the grouped video resources; a determination unit configured to determine status of the video resources based on the result of the real-time cyclic preview; and a reporting unit configured to report the status of the video resources to the central service module so that the central service module updates original status of the video resources to the determined status of the video resources and notifies the updated status of the video resources to other applications of the video management platform.

The present disclosure further provides a computer device. The computer device includes a memory, a processor, and a computer program stored in the memory and executable by the processor. When executing the computer program, the processor performs the steps of: acquiring a video resource list from the central service module; grouping video resources in the video resource list and performing a real-time cyclic preview of the grouped video resources; determining status of the video resources based on the result of the real-time cyclic preview; and reporting the status of the video resources to the central service module so that the central service module updates original status of the video resources to the determined status of the video resources and notifies the updated status of the video resources to other applications of the video management platform.

The present disclosure further provides a computer-readable storage medium. The computer-readable storage medium stores a computer program. When executed by the processor, the computer program, causes the processor to perform the steps of: acquiring a video resource list from the central service module; grouping video resources in the video resource list and performing a real-time cyclic preview of the grouped video resources; determining status of the video resources based on the result of the real-time cyclic preview; and reporting the status of the video resources to the central service module so that the central service module updates original status of the video resources to the determined status of the video resources and notifies the updated status of the video resources to other applications of the video management platform.

### BRIEF DESCRIPTION OF DRAWINGS

FIG. 1 is a flowchart of a video stream check method according to an embodiment.

FIG. 2 is a flowchart of a video stream check method according to another embodiment.

FIG. 3 is a flowchart of a video stream check method according to another embodiment.

FIG. 4 is a flowchart illustrating that detection software registers, logs in and acquires a video resource list according to an embodiment.

FIG. 5 is a flowchart of making a request for real-time videos and making a request to close the real-time videos according to an embodiment.

FIG. 6 is a flowchart of reporting the status of video streams according to an embodiment.

FIG. 7 is a block diagram of a video stream check system according to an embodiment.

FIG. 8 is a block diagram of a video stream check system according to another embodiment.

FIG. 9 is a block diagram of a computer device according to an embodiment.

### DETAILED DESCRIPTION

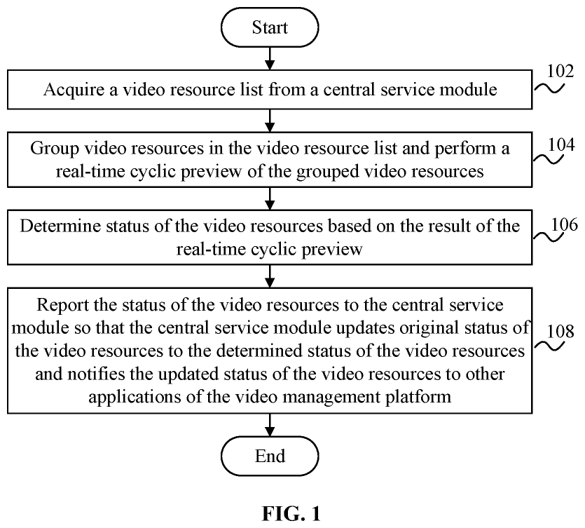

This embodiment provides a video stream check method. FIG. 1 is a flowchart of a video stream check method according to this embodiment. As shown in FIG. 1, the method includes the steps described below.

In step 102, a video resource list is acquired from a central service module.

In step 104, video resources in the video resource list are grouped and a real-time cyclic preview of the grouped video resources is performed.

In step 106, status of the video resources is determined based on the result of the real-time cyclic preview.

In step 108, the status of the video resources is reported to the central service module so that the central service module updates original status of the video resources to the determined status of the video resources and notifies the updated status of the video resources to other applications of the video management platform.

In the video stream check method provided in this embodiment, dedicated automatic detection software capable of automatically determining whether video streams are valid is deployed in the video management platform. The detection software may be deployed on a same hardware server as the video management platform. The detection software interacts with the central service module to acquire a video resource list, groups video resources in the acquired video resource list according to the load capacity of the hardware of the machine on which the detection software is deployed, previews the grouped video resources in turn, handles a real-time preview request for video resources in one group each time until video resources of all groups have been previewed, determines the status of the video resources according to the preview result of each group, and reports the available or unavailable status to the central service module. After receiving the status of a video resource, the central service module updates the status of the video resource. If the status of the video resource changes, the central service module notifies the status of the video resource to other relevant applications or software entities in the video management platform.

When the central service module receives a message indicating a change in the status of a video resource, where the message is actively sent by a device, the central service module also updates the status of the video resource and notifies the message indicating the change in the status of the video resource to other relevant software entities in the video management platform. In this manner, the validity of a video stream is checked in a manner in which all video resources in a video resource list are detected in turn; and detection software that has been developed and implemented is deployed and executed, so that whether a video stream is valid is detected automatically and the result is reported in real time. Thus, the validity of a video stream can be better detected on a platform connected to devices produced by different manufacturers; the problem in which the validity of a video stream cannot be determined accurately is alleviated, where this problem is caused by the following phenomenon: among cameras managed by a video management platform connected to devices produced by different manufacturers, real-time videos on some available cameras cannot be viewed while real-time videos on some unavailable cameras can be viewed; and the validity of a video stream can be determined more accurately.

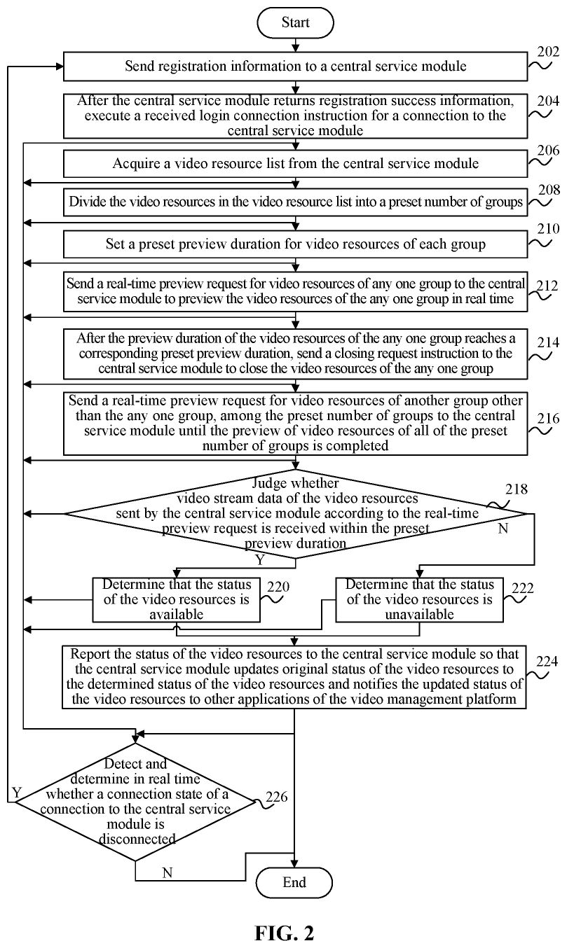

FIG. 2 is a flowchart of a video stream check method according to another embodiment. As shown in FIG. 2, the method includes the steps described below.

In step 202, registration information is sent to a central service module.

In step 204, after the central service module returns registration success information, a received login connection instruction is executed for a connection to the central service module.

In step 206, a video resource list is acquired from the central service module.

In step 208, the video resources in the video resource list are divided into a preset number of groups.

In step 210, a preset preview duration is set for video resources of each group.

In step 212, a real-time preview request for video resources of any one group is sent to the central service module to preview the video resources of the any one group in real time.

In step 214, after the preview duration of the video resources of the any one group reaches a corresponding preset preview duration, a closing request instruction is sent to the central service module to close the video resources of the any one group.

In step 216, a real-time preview request for video resources of another group, other than the any one group, among the preset number of groups is sent to the central service module until the preview of video resources of all of the preset number of groups is completed.

In step 218, it is judged whether video stream data of the video resources sent by the central service module according to the real-time preview request is received within the preset preview duration, if the video stream data is received within the preset preview duration, step 220 is performed; and if the video stream data is not received, step 222 is performed.

In step 220, the status of the video resources is determined to be available.

In step 222, the status of the video resources is determined to be unavailable.

In step 224, the status of the video resources is reported to the central service module so that the central service module updates original status of the video resources to the determined status of the video resources and notifies the updated status of the video resources to other applications of the video management platform.

In step 226, whether a connection state of a connection to the central service module is disconnected is detected and determined in real time. If the connection state is disconnected, the process returns to step 202; if the connection state is connected, the process ends.

The arrows pointing to step 226 from steps of step 204 to step 224 indicate whether the connection state of connection to the central service module is disconnected is detected in real time while step 204 to step 224 are being performed. If the connection state is disconnected, the process returns to step 202, and the registration information is resent to the central service module.

In an embodiment, before the video resource list is acquired from the central service module of the video management platform, the method further includes sending registration information to the central service module; and after the central service module returns registration success information, executing a received login connection instruction to connect to the central service module.

In this embodiment, before the process of checking the validity of video streams is started and after the detection software is deployed and started, the detection software automatically sends registration information to the central service module; and after the central service module returns registration success information and registration verification succeeds, the detection software receives a login instruction and connects to the central service module so that the detection software interacts data with the central service module to check video streams.

In an embodiment, grouping the video resources in the video resource list and performing the real-time cyclic preview of the grouped video resources includes: dividing the video resources in the video resource list into a preset number of groups; setting a preset preview duration for video resources of each group; sending a real-time preview request for video resources of any one group among the preset number of groups to the central service module to preview the video resources of the any one group in real time; after the preview duration of the video resources of the any one group reaches a corresponding preset preview duration, sending a closing request instruction to the central service module to close the video resources of the any one group; and sending a real-time preview request for video resources of another group, other than the any one group, among the preset number of groups to the central service module until the preview of video resources of all of the preset number of groups is completed.

In this embodiment, video resources in the video resource list are grouped and a real-time cyclic preview of the grouped video resources is performed as below.

The detection software is set according to the load capacity of the hardware of the machine on which the check software is deployed. The acquired video resources in the acquired video resource list are divided into a preset number of groups, where multiple video resources are in one group. The preview duration of each group is set to N seconds. The value of N is greater than 0 and is set according to network conditions. A request to preview radio resources of any one group (referred to as radio resources of a first group) is sent to the central service module. When the preview duration reaches N seconds, a request to close the radio resources of the first group is sent to the central service module. The preview of the radio resources of the first group is thus completed. Then a request to preview radio resources of a second group is sent to the central service module. After the preview of the radio resources of the second group is completed, a request to preview radio resources of a third group is sent to the central service module. Radio resources of the remaining groups are previewed in the same manner. The preview of all radio resources in the radio resource list is thus completed. Then the request to preview the radio resources of the first group is resent. After the preview of the first group is completed, the request to preview the radio resources of the second group is resent. The rest is done in the same manner. The radio resources in the radio resource list are continuously previewed in turn so that the radio resources are detected in real time.

In an embodiment, determining the status of the video resources based on the result of the real-time cyclic preview includes determining whether video stream data of the video resources sent by the central service module according to the real-time preview request is received within the preset preview duration; if the video stream data is not received, determining that the status of the video resources is unavailable; if the video stream data is received, determining that the status of the video resources is available.

In this embodiment, the step of determining status of the video resources based on the result of the real-time cyclic preview includes judging whether video stream data of the video resources sent by the central service module according to the real-time preview request is received within the preset preview duration; if the video stream data is not received, determining that the status of the video resources is unavailable; and if the video stream data is received, determining that the status of the video resources is available.

In an embodiment, a connection state of a connection to the central service module is detected in real time; the registration information is resent to the central service module when the connection state is disconnected.

In this embodiment, after the detection software connects to the central service module, the state of the connection to the central service module is detected in real time. If it is detected that the detection software is disconnected from the central service module at a time point, the detection software automatically resends the registration request. The video resources in the video resource list are not previewed in turn until the detection software is connected to the central service module. Such configuration reduces the possibility of wrong determination by avoiding the problem in which it is wrongly determined that the status of a video resource is unavailable since this requested video resource is not received due to network disconnection.

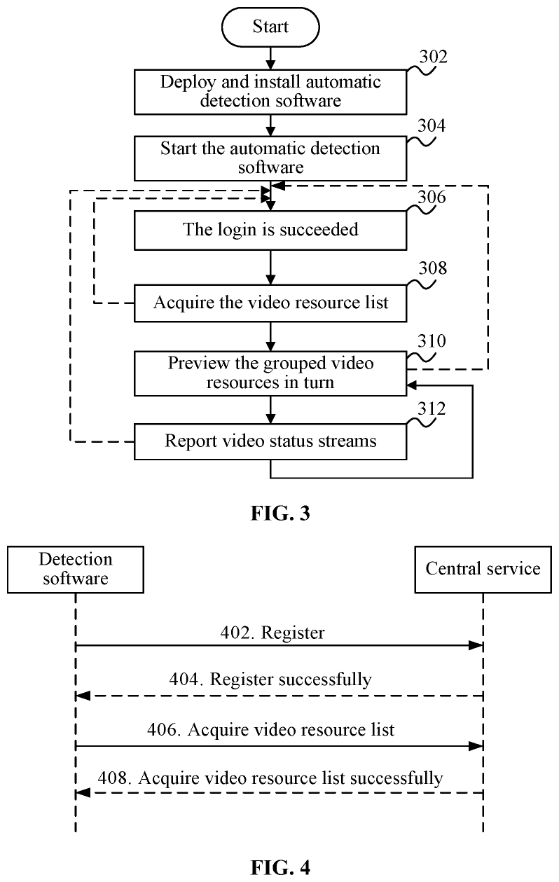

FIG. 3 is a flowchart of a video stream check method according to another embodiment. As shown in FIG. 3, the method includes the steps described below.

In step 302, automatic detection software is deployed and installed.

For example, it is assumed that a central service is C, the detection software is S, a video resource list managed by a management platform contains V1, V2, . . . , V99 and V100, S is installed, the address, username and password of C are set, videos are divided into 10 groups, each group is previewed for 10 seconds, and S and C may be deployed on the same machine.

In step 304, the automatic detection software is started.

The automatic detection software is started after S is installed. The registration and login process is shown in FIG. 4.

In step 306, the login is succeeded.

In step 308, the video resource list is acquired.

The process of acquiring the video resource list after the login succeeds is shown in

FIG. 4. In step 402, the detection software sends registration information to the central service module. In step 404, the central service module returns registration success information to the detection software. In step 406, the detection software makes a request to acquire the video resource list. In step 408, the detection software successfully acquires the video resource list from the central service module.

In step 310, the grouped video resources are previewed in turn.

For example, the detection software S automatically makes a request to preview real-time videos of video resource points of V1, V2, . . . , V9 and V10 simultaneously and calculates whether S receives the video stream data of each of V1, V2, . . . , V9 and V10 in 10 seconds. If the video stream data is received, it indicates that the status of this video resource is available. If the video stream data is not received, the status of this video resource is unavailable. After 10 seconds, S makes a request to C to close the real-time videos of V1, V2, . . . , V9 and V10. It is assumed that V1 and V2 are available and V3 and V4 are unavailable.

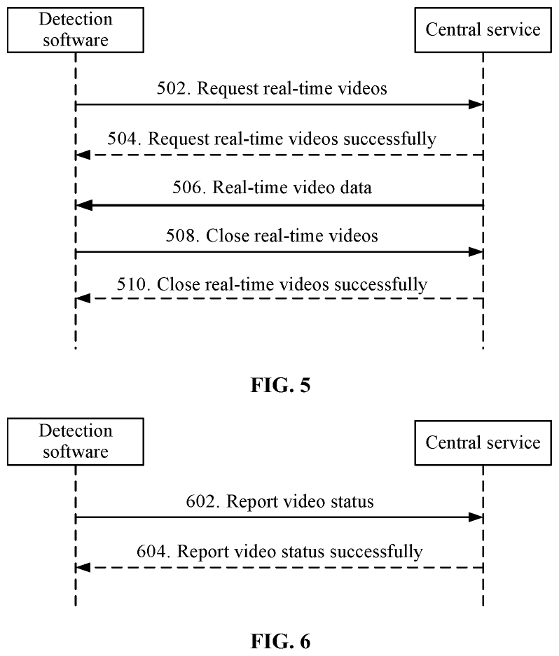

The process of making a request to preview radio resources and making a request to close the radio resources are shown in FIG. 5. In step 502, the detection software sends a request to preview radio resources in real time to the central service module. In step 504, the real-time preview request sent by the detection software succeeds, that is, the central service module approves the request. In step 506, the detection software successfully acquires the real-time video data and previews the videos. In step 508, after real-time video data of a real-time video is previewed for a preset preview duration, the detection software sends a request to close the real-time video data to the central service module. In step 510, the central service module responds to the request to close the real-time video data and closes the real-time video.

In step 312, video status streams are reported.

For example, S reports the status of videos of V1, V2, . . . , V9 and V10 to C. After receiving the reported status, C compares the reported status with the original status of the videos V1, V2, . . . , V9 and V10. Any change in the status is notified to other software entities in the video management platform. For example, if C finds that the original status of V1 is unavailable while the current status of V1 reported by S is available, then other software entities such as upper-level and lower-level gateways or clients in the video management platform are notified that the status of V1 is available. Similarly, if C finds that the original status of V3 is available while the current status of V3 reported by S is unavailable, then other software entities in the video management platform are notified that the status of V3 is unavailable. In addition, C may receive the status information of V1, V2, . . . , V9 and V10 sent by other devices, and in this case, C makes a similar comparison and any change in the status is notified to other software entities in the video management platform.

The process of reporting the status of video streams is shown in FIG. 6. In step 602, the detection software reports the status of the video resources to the central service module. In step 604, the central service module successfully receives the status of the video resources reported by the detection software, and thus the detection software successfully reports the video status.

After the detection of V1, V2, . . . , V9 and V10 is completed, step 310 is performed again to detect and report the status of another group containing 10 videos. Such operation is performed until the detection and reporting of the status of V1, V2, . . . , V99 and V100 are complete. Then, S continues to make a request for a new round of detection of the status of V1, V2, . . . , V9 and V10 to C.

If S is disconnected from C at a time point, S actively resends registration request information to C, and after registering and logging in again successfully, S acquires the video resource list and starts an automatic preview of the video resources in turn. This process is as shown in the steps indicated by dotted lines in FIG. 3.

In view of the problem in which the video management platform connected to a device produced by another manufacturer cannot accurately determine whether a video stream is valid, this embodiment provides a reasonable and accurate video stream check method as described below. The validity of a video stream is detected in a manner in which all video resources in a video resource list are detected in turn; and detection software that has been developed and implemented is deployed and executed, so that whether a video stream is valid is automatically detected and the result is reported in real time. Thus, the validity of a video stream can be better detected on a platform connected to devices produced by different manufacturers; and the problem in which the validity of a video stream cannot be determined accurately is more significantly alleviated as can be seen from the actual effects, where this problem is caused by the following phenomenon: among cameras managed by a video management platform connected to devices produced by different manufacturers, real-time videos on some available cameras cannot be viewed while real-time videos on some unavailable cameras can be viewed.

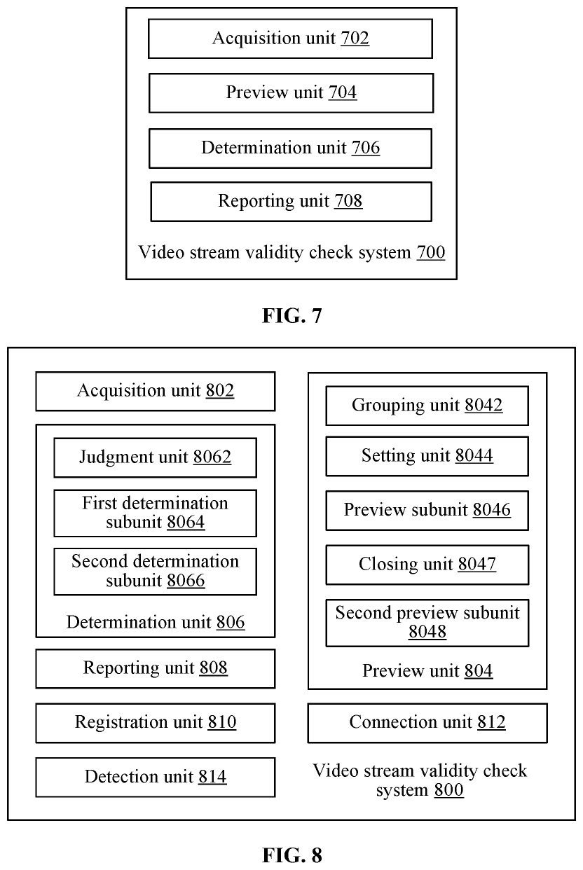

This embodiment further provides a video stream check system 700. FIG. 7 is a block diagram of a video stream check system according to this embodiment. The system includes an acquisition unit 702, a preview unit 704, a determination unit 706 and a reporting unit 708.

The acquisition unit 702 is configured to acquire a video resource list from a central service module.

The preview unit 704 is configured to group video resources in the video resource list and perform a real-time cyclic preview of the grouped video resources.

The determination unit 706 is configured to determine status of the video resources based on the result of the real-time cyclic preview.

The reporting unit 708 is configured to report the status of the video resources to the central service module so that the central service module updates original status of the video resources to the determined status of the video resources and notifies the updated status of the video resources to other applications of the video management platform.

In the video stream check system provided in this embodiment, dedicated automatic detection software capable of automatically determining whether video streams are valid is deployed in the video management platform. The detection software may be deployed on the same hardware server as the video management platform. The acquisition unit 702 is configured to interact with the central service module to acquire a video resource list. The preview unit 704 is configured to group video resources in the acquired video resource list according to the load capacity of the hardware of the machine on which the detection software is deployed, to preview the grouped video resources in turn, and to handle a real-time preview request for video resources in one group each time until a preview of video resources of all groups have been completed. The determination unit 706 is configured to determine the status of the video resources according to the preview result of each group. The reporting unit 708 is configured to report the available or unavailable status to the central service module. After receiving the status of a video resource, the central service module updates the status of the video resource. If the status of the video resource changes, the central service module notifies the status of the video resource to other relevant applications or software entities in the video management platform.

When the central service module receives a message indicating a change in the status of a video resource, where the message is actively sent by a device, the central service module also updates the status of the video resource and notifies the message indicating the change in the status of the video resource to other relevant software entities in the video management platform. In this manner, the validity of a video stream is checked in a manner in which all video resources in a video resource list are detected in turn; and detection software that has been developed and implemented is deployed and executed, whether a video stream is valid is automatically detected and the result is reported in real time. Thus, the validity of a video stream can be better detected on a platform connected to devices produced by different manufacturers; the problem in which the validity of a video stream cannot be determined accurately is alleviated, where this problem is caused by the following phenomenon: among cameras managed by a video management platform connected to devices produced by different manufacturers, real-time videos on some available cameras cannot be viewed while real-time videos on some unavailable cameras can be viewed; and the validity of a video stream can be determined more accurately.

FIG. 8 is a block diagram of a video stream check system 800 according to another embodiment. The video stream check system 800 includes an acquisition unit 802, a preview unit 804, a determination unit 806, a reporting unit 808, a registration unit 810, a connection unit 812 and a check unit 814.

The acquisition unit 802 is configured to acquire a video resource list from a central service module.

The preview unit 804 is configured to group video resources in the video resource list and perform a real-time cyclic preview of the grouped video resources.

The determination unit 806 is configured to determine status of the video resources based on the result of the real-time cyclic preview.

The reporting unit 808 is configured to report the status of the video resources to the central service module so that the central service module updates original status of the video resources to the determined status of the video resources and notifies the updated status of the video resources to other applications of the video management platform.

The registration unit 810 is configured to send registration information to the central service module.

The connection unit 812 is configured to execute a received login connection instruction to connect to the central service module after the central service module returns registration success information.

The check unit 814 is configured to detect connection state of connection to the central service module in real time.

The connection unit 812 is further configured to resend the registration information to the central service module when the connection state is disconnected.

The preview unit 804 includes a grouping unit 8042, a setting unit 8044, a first preview subunit 8046, a closing unit 8047 and a second preview subunit 8048.

The grouping unit 8042 is configured to divide the video resources in the video resource list into a preset number of groups.

The setting unit 8044 is configured to set a preset preview duration for video resources of each group among the preset number of groups.

The first preview subunit 8046 is configured to send a real-time preview request for video resources of any one group among the preset number of groups to the central service module to preview the video resources of the any one group in real time.

The closing unit 8047 is configured, after the preview duration of the video resources of the any one group reaches a corresponding preset preview duration, to send a closing request instruction to the central service module to close the video resources of the any one group.

The second preview subunit 8048 is configured to send a real-time preview request for video resources of another group among the preset number of groups other than the any one group to the central service module until a preview of video resources of all of the preset number of groups is completed.

The determination unit 806 includes a determination unit 8062, a first determination subunit 8064 and a second determination subunit 8066.

The judgment unit 8062 is configured to judge whether video stream data of the video resources sent by the central service module according to the real-time preview request is received within the preset preview duration.

The first determination subunit 8064 is configured to determine that the status of the video resources is unavailable if the video stream data is not received.

The second determination subunit 8066 is configured to determine that the status of the video resources is available if the video stream data is received.

In an embodiment, the he registration unit 810 is configured to send registration information to the central service module; and the connection unit 812 is configured to execute a received login connection instruction to connect to the central service module after the central service module returns registration success information.

In this embodiment, before the process of detecting the validity of video streams is started and after the detection software is deployed and started, the registration unit 810 is configured to automatically send registration information to the central service module; and after the central service module returns registration success information and registration verification succeeds, the connection unit 812 receives a login instruction and connects to the central service module so that the detection software interacts data with the central service module to detect the validity of video streams.

In an embodiment, the preview unit 804 includes a grouping unit 8042, a setting unit 8044, a first preview subunit 8046, a closing unit 8047 and a second preview subunit 8048. The grouping unit 8042 is configured to divide the video resources in the video resource list into a preset number of groups. The setting unit 8044 is configured to set a preset preview duration for video resources of each group among the preset number of groups. The first preview subunit 8046 is configured to send a real-time preview request for video resources of any one group among the preset number of groups to the central service module to preview the video resources of the any one group in real time. The closing unit 8047 is configured to send a closing request instruction to the central service module to close the video resources of the any one group after the preview duration of the video resources of the any one group reaches a corresponding preset preview duration. The second preview subunit 8048 is configured to send a real-time preview request for video resources of another group among the preset number of groups other than the any one group to the central service module until the preview of video resources of all of the preset number of groups is completed.

In this embodiment, the preview unit 804 groups video resources in the video resource list and performs a real-time cyclic preview of the grouped video resources as below.

The grouping unit 8042 sets the detection software according to the load capacity of the hardware of the machine on which the detection software is deployed, and divides the acquired video resources in the acquired video resource list into a preset number of groups. The setting unit 8044 sets the preview duration of each group to N seconds. The value of N is greater than 0 and set according to network conditions. The first preview subunit 8046 sends a request to preview radio resources of any one group (referred to as radio resources of a first group) to the central service module. When the preview duration reaches N seconds, the closing unit 8047 sends a request to close the radio resources of the first group to the central service module. The preview of the radio resources of the first group is thus completed. Then the second preview subunit 8048 sends a request to preview radio resources of a second group to the central service module. After the preview of the radio resources of the second group is completed, a request to preview radio resources of a third group is sent to the central service module. Radio resources of the remaining groups are previewed in the same manner. The preview of all radio resources in the radio resource list is thus completed. Then the request to preview the radio resources of the first group is resent. After the preview of the first group is completed, the request to preview the radio resources of the second group is resent. The rest is done in the same manner. The radio resources in the radio resource list are continuously previewed in turn so that the radio resources are detected in real time.

In an embodiment, the determination unit 806 includes a judgment unit 8062, a first determination subunit 8064 and a second determination subunit 8066. The judgment unit 8062 is configured to judge whether video stream data of the video resources sent by the central service module according to the real-time preview request is received within the preset preview duration. The first determination subunit 8064 is configured to determine that the status of the video resources is unavailable if the video stream data is not received. The second determination subunit 8066 is configured to determine that the status of the video resources is available if the video stream data is received.

In this embodiment, the determination unit 806 determines the status of the video resources based on the result of the real-time cyclic preview in the manner described below. After a request to preview radio resources of a first group is sent, the judgment unit 8062 calculates whether the video stream data of a video resource is received within the preset duration. If the video stream data is received within the preset duration, the video resource is available and the second determination subunit 8066 determines that the status of the video resource is available. If the video stream data is not received within the preset duration, the video resource is unavailable and the first determination subunit 8066 determines that the status of the video resource is unavailable. In this manner, the status of the video resources is detected.

In an embodiment, the check unit 814 is configured to detect a connection state of a connection to the central service module in real time; and the connection unit 812 is further configured to resend the registration information to the central service module when the connection state is disconnected.

In this embodiment, after the detection software connects to the central service module, the check unit 814 detects the state of the connection to the central service module in real time. If the check unit 814 detects that the detection software is disconnected from the central service module at a time point, the connection unit 812 automatically resends the registration request. The video resources in the video resource list are not previewed in turn until the detection software is connected to the central service module. Such configuration reduces the possibility of wrong determination by avoiding the problem in which it is wrongly determined that the status of a video resource is unavailable since this requested video resource is not received due to network disconnection.

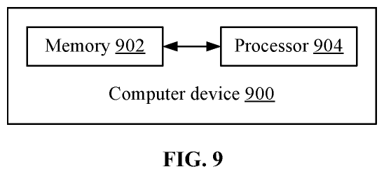

This embodiment further provides a computer device. FIG. 9 is a block diagram of a computer device according to this embodiment.

The computer device 900 includes a memory 902, a processor 904, and a computer program stored in the memory 902 and executable by the processor 904. The processor 904 executes the computer program to perform the steps of acquiring a video resource list from the central service module; grouping video resources in the video resource list and performing a real-time cyclic preview of the grouped video resources; determining status of the video resources based on the result of the real-time cyclic preview; and reporting the status of the video resources to the central service module so that the central service module updates original status of the video resources to the determined status of the video resources and notifies the updated status of the video resources to other applications of the video management platform.

In the computer device 900 provided in this embodiment, the processor 904 executes the computer program to perform the steps described below. Dedicated automatic detection software capable of automatically determining whether video streams are valid is deployed in a video management platform. The detection software may be deployed on the same hardware server as the video management platform. The detection software interacts with a central service module to acquire a video resource list, groups video resources in the acquired video resource list according to the load capacity of the hardware of the machine on which the detection software is deployed, previews the grouped video resources in turn, handles a real-time preview request for video resources in one group each time until video resources of all groups have been previewed, determines the status of the video resources according to the preview result of each group, and reports the available or unavailable status to the central service module. After receiving the status of a video resource, the central service module updates the status of the video resource. If the status of the video resource changes, the central service module notifies the status of the video resource to other relevant applications or software entities in the video management platform.

When the central service module receives a message indicating a change in the status of a video resource, where the message is actively sent by a device, the central service module also updates the status of the video resource and notifies the message indicating the change in the status of the video resource to other relevant software entities in the video management platform. In this manner, the validity of a video stream is detected in a manner in which all video resources in a video resource list are detected in turn; and detection software that has been developed and implemented is deployed and executed, whether a video stream is valid is automatically detected and the result is reported in real time. Thus, the validity of a video stream can be better detected on a platform connected to devices produced by different manufacturers; the problem in which the validity of a video stream cannot be determined accurately is alleviated, where this problem is caused by the following phenomenon: among cameras managed by a video management platform connected to devices produced by different manufacturers, real-time videos on some available cameras cannot be viewed while real-time videos on some unavailable cameras can be viewed; and the validity of a video stream can be determined more accurately.

This embodiment further provides a computer-readable storage medium. The computer-readable storage medium stores a computer program. The processor executes the computer program to perform the steps of acquiring a video resource list from a central service module; grouping video resources in a video resource list and performing a real-time cyclic preview of the grouped video resources; determining status of the video resources based on the result of the real-time cyclic preview; and reporting the status of the video resources to the central service module so that the central service module updates original status of the video resources to the determined status of the video resources and notifies the updated status of the video resources to other applications of the video management platform.

The computer-readable storage medium provided in this embodiment stores a computer program. The processor executes the computer program to perform the steps described below. Dedicated automatic detection software capable of automatically determining whether video streams are valid is deployed in a video management platform. The detection software may be deployed on the same hardware server as the video management platform. The detection software interacts with a central service module to acquire a video resource list, groups video resources in the acquired video resource list according to the load capacity of the hardware on which the detection software is deployed, previews the grouped video resources in turn, handles a real-time preview request for video resources in one group each time until video resources of all groups have been previewed, determines the status of the video resources according to the preview result of each group, and reports the available or unavailable status to the central service module. After receiving the status of a video resource, the central service module updates the status of the video resource. If the status of the video resource changes, the central service module notifies the status of the video resource to other relevant applications or software entities in the video management platform.

When the central service module receives a message indicating a change in the status of a video resource, where the message is actively sent by a device, the central service module also updates the status of the video resource and notifies the message indicating the change in the status of the video resource to other relevant software entities in the video management platform. In this manner, the validity of a video stream is detected in a manner in which all video resources in a video resource list are detected in turn; and detection software that has been developed and implemented is deployed and executed, whether a video stream is valid is automatically detected and the result is reported in real time. Thus, the validity of a video stream can be better detected on a platform connected to devices produced by different manufacturers; the problem in which the validity of a video stream cannot be determined accurately is alleviated, where this problem is caused by the following phenomenon: among cameras managed by a video management platform connected to devices produced by different manufacturers, real-time videos on some available cameras cannot be viewed while real-time videos on some unavailable cameras can be viewed; and the validity of a video stream can be determined more accurately.

Description of the terms “an embodiment”, “some embodiments” and “detailed embodiments” in the above embodiments means that features, structures, materials or characteristics described in connection with these embodiments or examples are included in at least one of the above embodiments or examples. The features, structures, materials or characteristics described in the above embodiments may be combined in any one or more embodiments or examples in a proper manner.

1. A video stream check method, applied to a video management platform which comprises a central service module, comprising:
acquiring a video resource list from the central service module;
grouping video resources in the video resource list, and performing a real-time cyclic preview of the grouped video resources;
determining status of the video resources based on a result of the real-time cyclic preview; and
reporting the status of the video resources to the central service module, so that the central service module updates original status of the video resources to the determined status of the video resources and notifies the updated status of the video resources to other applications of the video management platform.

2. The method of claim 1, wherein before acquiring the video resource list from the central service module of the video management platform, the method further comprises:
sending registration information to the central service module; and
after the central service module returns registration success information, executing a received login connection instruction to connect to the central service module.

3. The method of claim 1, wherein grouping the video resources in the video resource list and performing the real-time cyclic preview of the grouped video resources comprises:
dividing the video resources in the video resource list into a preset number of groups;
setting a preset preview duration for video resources of each group among the preset number of groups;
sending a real-time preview request for video resources of any one group among the preset number of groups to the central service module to preview the video resources of the any one group in real time;
after a preview duration of the video resources of the any one group reaches a corresponding preset preview duration, sending a closing request instruction to the central service module to close the video resources of the any one group; and
sending a real-time preview request for video resources of another group, other than the any one group, among the preset number of groups to the central service module until a preview of video resources of all of the preset number of groups is completed.

4. The method of claim 3, wherein determining the status of the video resources based on the result of the real-time cyclic preview comprises:
judging whether video stream data of the video resources sent by the central service module according to the real-time preview request is received within the preset preview duration;
in response to determining that the video stream data is not received, determining that the status of the video resources is unavailable; and
in response to determining that the video stream data is received, determining that the status of the video resources is available.

5. The method of claim 2, further comprising:
detecting a connection state of a connection to the central service module in real time; and
resending the registration information to the central service module when the connection state is disconnected.

6. A video stream check system, applied to a video management platform which comprises a central service module, comprising:
an acquisition unit, configured to acquire a video resource list from the central service module;
a preview unit, configured to group video resources in the video resource list, and perform a real-time cyclic preview of the grouped video resources;
a determination unit, configured to determine status of the video resources based on a result of the real-time cyclic preview; and
a reporting unit, configured to report the status of the video resources to the central service module, so that the central service module updates original status of the video resources to the determined status of the video resources and notifies the updated status of the video resources to other applications of the video management platform.

7. The system of claim 6, further comprising:
a registration unit, configured to send registration information to the central service module; and
a connection unit, configured to execute a received login connection instruction to connect to the central service module after the central service module returns registration success information.

8. The system of claim 6, wherein the preview unit comprises:
a grouping unit, configured to divide the video resources in the video resource list into a preset number of groups;
a setting unit, configured to set a preset preview duration for video resources of each group among the preset number of groups;
a first preview subunit, configured to send a real-time preview request for video resources of any one group among the preset number of groups to the central service module to preview the video resources of the any one group in real time;
a closing unit, configured to send a closing request instruction to the central service module to close the video resources of the any one group after a preview duration of the video resources of the any one group reaches a corresponding preset preview duration; and
a second preview subunit, configured to send a real-time preview request for video resources of another group, other than the any one group, among the preset number of groups to the central service module until a preview of the video resources of all of the preset number of groups is completed.

9. The system of claim 8, wherein the determination unit comprises:
a judgment unit, configured to judge whether video stream data of the video resources sent by the central service module according to the real-time preview request is received within the preset preview duration;
a first determination subunit, configured to determine that the status of the video resources is unavailable in response to determining that the video stream data is not received; and
a second determination subunit, configured to determine that the status of the video resources is available in response to determining that the video stream data is received.

10. The system of claim 7, further comprising:
a check unit, configured to detect a connection state of a connection to the central service module in real time,
wherein the connection unit is further configured to resend the registration information to the central service module when the connection state is disconnected.

11. A computer device, comprising a memory, a processor, and a computer program stored in the memory and executable by the processor, wherein when executing the computer program, the processor performs the video stream check method of claim 1.

12. A non-transitory computer-readable storage medium, which stores a computer program, wherein the computer program, when executed by a processor, causes the processor to perform the following steps:
acquiring a video resource list from the central service module;
grouping video resources in the video resource list, and performing a real-time cyclic preview of the grouped video resources;
determining status of the video resources based on a result of the real-time cyclic preview; and
reporting the status of the video resources to the central service module, so that the central service module updates original status of the video resources to the determined status of the video resources and notifies the updated status of the video resources to other applications of the video management platform.

13. The method of claim 2, wherein grouping the video resources in the video resource list and performing the real-time cyclic preview of the grouped video resources comprises:
dividing the video resources in the video resource list into a preset number of groups;
setting a preset preview duration for video resources of each group among the preset number of groups;
sending a real-time preview request for video resources of any one group among the preset number of groups to the central service module to preview the video resources of the any one group in real time;
after a preview duration of the video resources of the any one group reaches a corresponding preset preview duration, sending a closing request instruction to the central service module to close the video resources of the any one group; and
sending a real-time preview request for video resources of another group, other than the any one group, among the preset number of groups to the central service module until a preview of video resources of all of the preset number of groups is completed.

14. The method of claim 3, further comprising:
detecting a connection state of a connection to the central service module in real time; and
resending the registration information to the central service module when the connection state is disconnected.

15. The method of claim 4, further comprising:
detecting a connection state of a connection to the central service module in real time; and
resending the registration information to the central service module when the connection state is disconnected.

16. The system of claim 7, wherein the preview unit comprises:
a grouping unit, configured to divide the video resources in the video resource list into a preset number of groups;
a setting unit, configured to set a preset preview duration for video resources of each group among the preset number of groups;
a first preview subunit, configured to send a real-time preview request for video resources of any one group among the preset number of groups to the central service module to preview the video resources of the any one group in real time;
a closing unit, configured to send a closing request instruction to the central service module to close the video resources of the any one group after a preview duration of the video resources of the any one group reaches a corresponding preset preview duration; and
a second preview subunit, configured to send a real-time preview request for video resources of another group, other than the any one group, among the preset number of groups to the central service module until a preview of the video resources of all of the preset number of groups is completed.

17. The system of claim 8, further comprising:
a check unit, configured to detect a connection state of a connection to the central service module in real time,
wherein the connection unit is further configured to resend the registration information to the central service module when the connection state is disconnected.

18. The system of claim 9, further comprising:
a check unit, configured to detect a connection state of a connection to the central service module in real time,
wherein the connection unit is further configured to resend the registration information to the central service module when the connection state is disconnected.

19. The storage medium of claim 12, wherein the computer program, when executed by a processor, causes the processor to further perform the following steps:
sending registration information to the central service module; and
after the central service module returns registration success information, executing a received login connection instruction to connect to the central service module.

20. The storage medium of claim 12, wherein the computer program, when executed by a processor, causes the processor to further perform the following steps:
dividing the video resources in the video resource list into a preset number of groups;
setting a preset preview duration for video resources of each group among the preset number of groups;
sending a real-time preview request for video resources of any one group among the preset number of groups to the central service module to preview the video resources of the any one group in real time;
after a preview duration of the video resources of the any one group reaches a corresponding preset preview duration, sending a closing request instruction to the central service module to close the video resources of the any one group; and
sending a real-time preview request for video resources of another group, other than the any one group, among the preset number of groups to the central service module until a preview of video resources of all of the preset number of groups is completed.
